(19) United States
(12) Patent Application Publication
(10) Pub. No.: US 2007/0254727 A1
(43) Pub. Date: Nov. 1, 2007

(54) Hotspot Power Regulation

(76) Inventors: Pat Sewall, Boise, ID (US); Dave Johnson, Boise, ID (US)

Correspondence Address: Jack H. McKinney;Ormiston & McKinney, P.O. Box 298, 802 W. Bannock, Suite 402, Boise, ID, 83701-0298, US

(21) Appl. No.: 11/673,965

(22) Filed: Feb. 12, 2007

Related U.S. Application Data
(63) Continuation-in-part of application No. 10/936,124, filed on Sep. 8, 2004.
(60) Provisional application No. 60/772,731, filed on Feb. 13, 2006.

(51) Int. Cl. H04M 1/00

(52) U.S. Cl. 455/574

(57) ABSTRACT

An embodiment is directed to a power regulation method implemented by a personal hotspot. The personal hotspot is configured to utilize a data exchanger to provide internet access to one or more client devices. The method includes monitoring a power state of one or both of the data exchanger and the personal hotspot. It is determined if the monitored power state meets a predetermined threshold value. If the determination indicates that the predetermined threshold value is met, a power regulation action associated with the threshold value is initiated.

### CROSS REFERENCE TO RELATED APPLICATIONS

This application claims the priority of provisional applications 60/772,731 entitled Power Management of an Access Point filed Feb. 13, 2006 and hereby incorporated by reference. Application 60/722,731 is incorporated herein by reference. This application is a continuation in part of application number 10/936,124 entitled Device Cradle filed Sep. 8, 2004. Application 10/936,124 is incorporated herein by reference.

### BACKGROUND

When internet access points are not in use, and imminent use is not likely, it is sometimes useful to lower power consumption, even at the loss of functionality and response time. The state of reduced power consumption is beneficial in general, but is especially useful when the access point and related hardware are battery powered, and therefore have a limited amount of power available.

### DESCRIPTION OF THE DRAWINGS

FIGS. 1 and 2 illustrate an exemplary block diagrams of environments in which embodiments of the present invention can be implemented.

FIGS. 3-6 are block diagrams showing physical and logical components of a personal hotspot according to an embodiment of the present invention.

FIG. 7 is an exemplary flow diagram illustrating steps taken in performance of various embodiments of the present invention.

### DETAILED DESCRIPTION

INTRODUCTION: Embodiments of the present invention allow a user to connect to the internet using a device such as an internet enabled cellular telephone. With a personal hotspot, multiple users of computing devices such as lap top computers, desktop computers, and personal digital assistants (PDAs) can access the internet simultaneously through the data capabilities of that cellular telephone. The combination of the personal hotspot and the internet enabled cellular telephone can provide an internet-connected wireless network anywhere that there is cellular data coverage.

A personal hotspot and accompanying internet enabled cellular telephone may each be battery powered. Further, energy from the battery of one device may be used to power both. Various embodiments described below operate to selectively regulate the power made available to and consumed by each device.

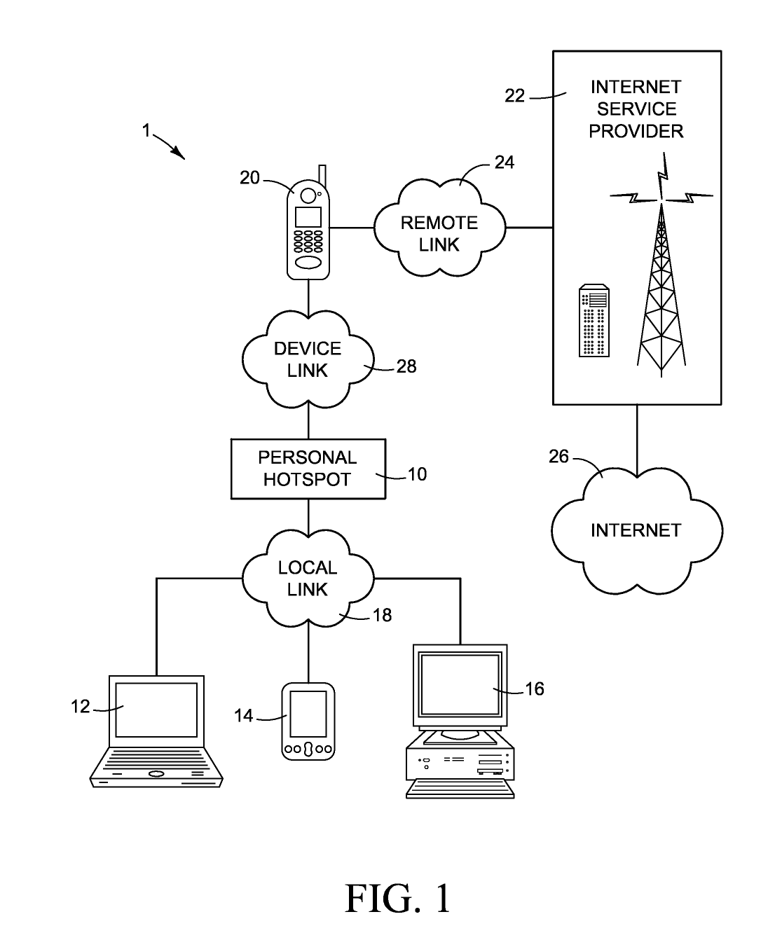

ENVIRONMENT: FIG. 1 illustrates exemplary environment 1 in which various embodiments of the present invention may be implemented. Environment 1 includes personal hotspot 10 and client devices 12, 14, and 16 and local link 18. Personal hotspot 10, discussed in more detail later, represents generally a device capable or routing network communications between client devices 12, 14, and 16 and internet 26 via a data exchanger 20. Client devices 12, 14, and 16 represent generally any computing devices capable of communicating with personal hotspot 10.

Local link 18 interconnects personal hotspot 10 and client devices 12, 14, 16. Local link 18 represents generally a cable, wireless, or remote link via a telecommunication link, an infrared link, a radio frequency link, or any other connector or system that provides electronic communication between devices 10, 12, 14, and 16. The path followed by link 18 between devices 10, 12, 14, and 1 in the schematic view of FIG. 1 represents the logical communication path between these devices, not necessarily the physical path between the devices. Devices 10, 12, 14, and 16 can be connected at any point and the appropriate communication path established logically between the devices.

Environment 1 also includes data exchanger 20 and service provider 22. Data exchanger 20 represents generally and combination of hardware and/or programming that can be utilized by personal hotspot 10 to connect to a remote network such as the internet. While illustrated as an internet enabled cellular telephone, data exchanger 20 is not so limited. Other examples include but are not limited to DSL modems and cable modems.

Service provider 22 represents generally any infrastructure configured to provide internet related data services to subscribers such as an owner of data exchanger 20. For example, where data exchanger 20 is an internet enabled cellular telephone, service provider 22 may be a cellular telephone service provider capable of providing voice and data services to subscribers allowing access to internet 26. Where data exchanger 22 is a DSL or cable modem, service provider 22 may be a more traditional internet service provider (ISP) providing data access to internet 26.

Remote link 24 interconnects data exchanger 20 and service provider 22 and represents generally any combination of a cable, wireless, or remote connection via a telecommunication link, an infrared link, a radio frequency link, or any other connector or system that provides electronic communication between data exchanger 20 and service provider 22. Remote link 30 may represent an intranet, an internet, or a combination of both.

In the embodiment illustrated in environment 1, device link 28 interconnects personal hotspot 10 and data exchanger 20. Device link 28 represents generally any combination of a cable, wireless, or remote connection via a telecommunication link, an infrared link, a radio frequency link, or any other connector or system that provides electronic communication between devices 10 and 20. As examples, device link 28 may incorporate a physical USB cable or radio waves carrying Bluetooth communications.

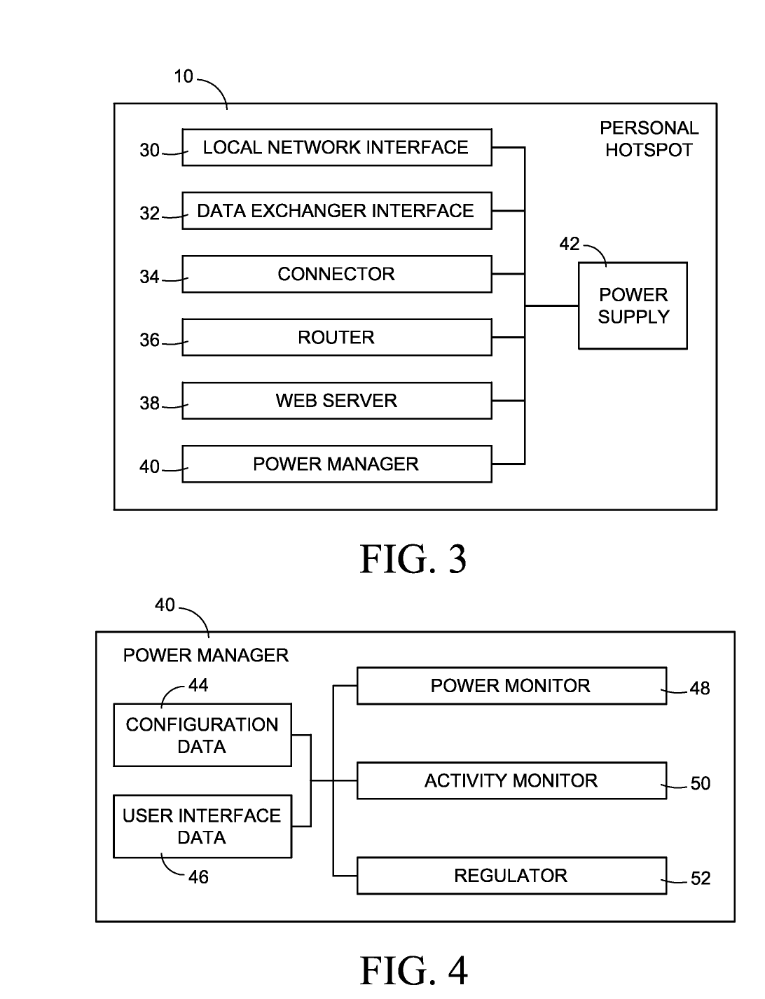

Communication between client devices 12, 14, and 16 and internet 26 is dependent upon personal hotspot 10. Personal hotspot 10, as discussed below with respect to FIGS. 3-6, includes components capable of power regulation for personal hotspot 10 and data exchanger 20.

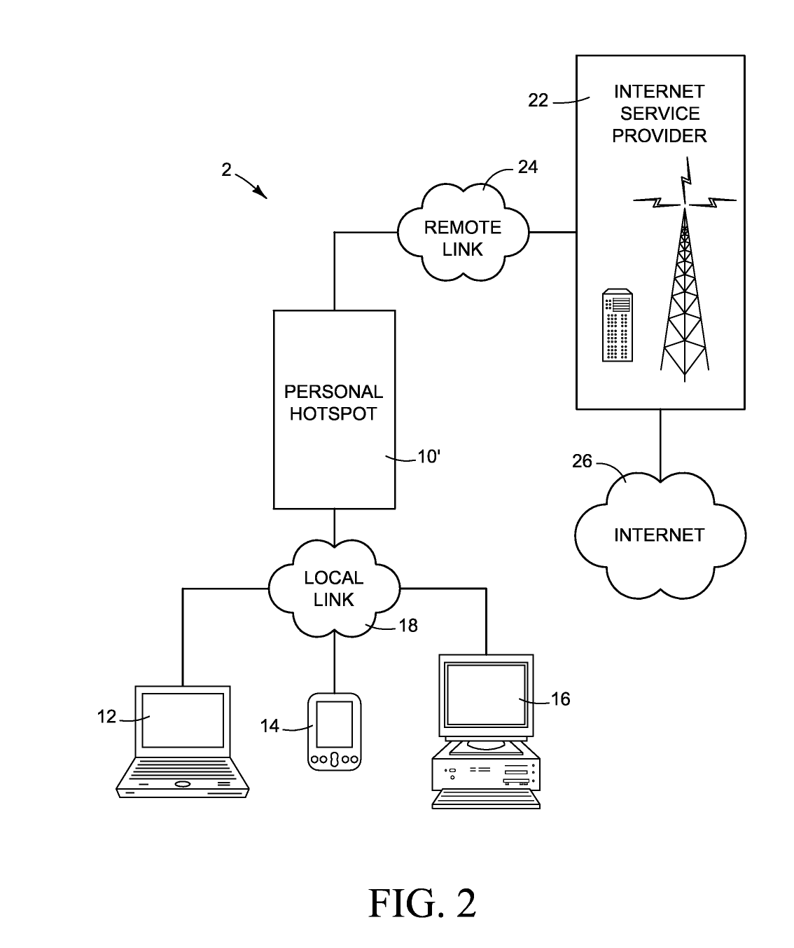

FIG. 2 illustrates another exemplary environment 2 in which various embodiments of the present invention may be implemented. In the example of FIG. 2, data exchanger 20 (not shown) and personal hotspot 10 are incorporated within the same device. Device link 32 (shown in FIG. 1) is eliminated and replaced with internal connections. In such a scenario, data exchanger may take the form of a card such as a PCMCIA card that can be inserted into a slot provided by personal hotspot 10. Alternatively, data exchanger 20 may be fully integrated into personal hotspot 10

PERSONAL HOTSPOT: FIG. 3 is a block diagram illustrating physical and logical components of personal hotspot 10. As described above, personal hotspot 10 represents generally any combination of hardware and/or programming capable functioning as a router for directing network communications between client devices and the internet via a data exchanger such as an internet enabled cellular telephone, DSL modem, or cable modem.

In the example of FIG. 3 personal hotspot 10 includes local network interface 30 and data exchanger interface 32. Local network interface 30 represents generally any combination of hardware and/or program instructions capable of supplying a communication interface between personal hotspot 10 and client devices 12, 14, and 16 shown in FIGS. 1 and 2. Data exchanger interface 32 represents any combination of hardware and/or programming enabling data to be communicated between personal hotspot 10 and a data exchanger 20 shown in FIGS. 1. For example, interfaces 30 and 32 may include a transceiver operable to exchange network communications utilizing a wireless protocol such as ultrawideband (UWB), Bluetooth, or 802.11. Alternatively, interfaces 30 and 32 may include physical ports or other physical connection points enabling wired communication.

Personal hotspot 10 also includes connector 34, router 36, web server 38, power manager 40, and power supply 42. Power supply 42 represents generally any hardware capable of supplying power to personal hotspot 10. Power supply 42, for example, could be a battery or a transformer capable of converting household current into a form useable by personal hotspot 10. Personal hotspot 10 may in turn utilize power supply 42 to power data exchanger 20 via data exchanger interface 32. For example, data exchanger interface may be a wired USB interface such that personal hotspot 10 serves as the master device and data exchanger serves as a USB client device. In this manner, data exchanger interface 32 can provide a typical five volt USB power supply to data exchanger 20. In other embodiments, personal hotspot 10 might serve as a USB client device with data exchanger 20 serving as the master. In this scenario, data exchanger 20 may supply power to personal hotspot 10. In other embodiments, each device may be capable of powering the other.

Connector 34 represents generally any combination of hardware and/or programming for sending a signal to data exchanger 20 to connect to establish a data connection with service provider 22 so that access can be made to internet 26. For example, where a data exchanger 20 is a cellular telephone, connector 34 may send a signal causing the cellular telephone to establish such a data link with service provider 22.

Router 36 represents generally any combination of hardware and/or programming for routing network communication received through network interface 30 to be transmitted by data exchanger 20 to internet 26. Router 36 is also responsible for routing inbound network communications received from internet 26 and directed via network interface 30 to a specified client device 12, 14, or 16. Outbound and inbound network communications, for example can be an IP (internet Protocol) packets directed to a target on internet 26 or to a particular network device 12, 14, or 16 on a local area network.

Web server 38 represents generally any combination of hardware and/or programming capable of serving interfaces such as web pages to client devices 12, 14, and 16. Such web pages may include web pages that when displayed by a network device allows a user to provide or otherwise select settings related to the operation of personal hotspot 10.

Power manager 40, discussed in more detail below with respect to FIG. 4, represents generally any combination of hardware and/or programming capable of selectively regulating the power state of personal hotspot 10 and data exchanger 20. The power state of a given device relates to an operational mode of that device where that mode causes the device to consume a certain amount energy. This energy may be provided by power source 42 and a power source such as a battery integrated in data exchanger 20. In many cases, a full operational mode consumes the most energy while a “sleep” mode consumes the least except when the device is powered off.

FIG. 4 is a block diagram illustrating physical and logical components of power manager 40. In this example, power manager 40 is shown to include configuration data 44, user interface data 46, power monitor 48, activity monitor 50, and regulator 52.

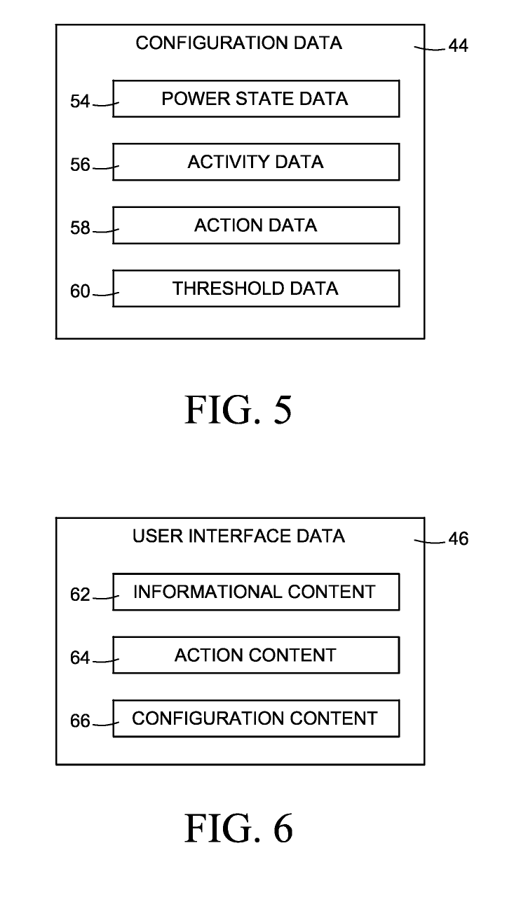

Configuration data 42, discussed in more detail below with respect to FIG. 5, represents generally a collection of information used by power manager 40 to select and set the operational states for personal hotspot 10 and data exchanger 20. As discussed above, different operational states consume different levels of power. User interface data 46, discussed in more detail below with respect to FIG. 6, represents data used to present a client device with user interfaces such as web pages or other content that can be served to a client device. Such user interfaces can be informational or they can provide controls for selecting an operational state.

Power monitor 48 represents generally any combination of hardware and/or programming capable of monitoring the power states of personal hotspot 10 and data exchanger 20. Power monitor 48 may record monitored power states in configuration data 44. The power state of a given device can indicate that it is functioning on battery power or on household current. If operating on battery power, the power state can indicate a remaining power level for that battery. For example, power monitor 48 may be responsible for monitoring battery levels for personal hotspot 10 and data exchanger 20. With respect to data exchanger 20, power monitor 40 may use data exchanger interface 32 (FIG. 3) to interrogate data exchanger 20 as to its battery level. Power monitor 48 may have access to a library of commands specific to data exchanger 20 that can be issued via device link 28 (FIG. 1). One or more of those commands may be for requesting data identifying whether or not the data exchanger is operating on battery power as well as a battery level. Low battery levels can indicate that personal hotspot 10 and data exchanger 20 can be placed in operational modes that require less power.

Activity monitor 50 represents generally any combination of hardware and/or programming capable of monitoring activity levels with respect to personal hotspot 10 and data exchanger 20. Activity monitor 50 may record monitored activity levels in configuration data 44. Referring back to FIG. 1, personal hotspot 10 is used to establish a private local network among client devices 12, 14, and 16. Activity monitor 50 may be responsible for monitoring activity levels in the form of local network communications between client devices 12, 14, and 16 and personal hotspot 10. In doing so, activity monitor may identify periods of inactivity with respect to the local private network. Such periods of inactivity may indicate that personal hotspot 10 can be placed in an operational mode that consumes less power.

Activity monitor 50 may also be responsible for monitoring activity levels in the form of data communications passing to and from data exchanger 22 via remote link 24. This may be accomplished by monitoring data communications passing between personal hotspot 10 and data exchanger 20 via device link 28. Alternatively, activity monitor 48 may have access to a library of commands specific to data exchanger 20 that can be issued via device link 28 (FIG. 1). One or more of those commands may be for requesting data identifying periods of activity or inactivity with respect to data communications via remote link 24. Periods of inactivity may indicate that data exchanger 20 can be placed in an operational mode that consumes less power.

Regulator 52 represents generally any combination of hardware and/or programming capable of regulating the power consumption of personal hotspot 10 and data exchanger 20. Regulator 52 does so by altering the operational states of those devices based on the power states and activity levels monitored by power monitor 48 and activity monitor 50 and recorded in configuration data 44.

As examples, regulator 52 may examine configuration data 44 and cause personal hotspot 10 or data exchanger 20 to enter a sleep mode or to power off following a monitored period of inactivity that exceeds a predetermined threshold duration or when a power state falls below threshold level. Where data exchanger 20 is being powered by personal hotspot 10, regulator 52 may cause data exchanger 20 to enter a self-powered mode when power state of personal hotspot 10 falls below a threshold level. Similarly, regulator 52 may cause personal hotspot 10 to power data exchanger 20 when a power state of personal hotspot 10 indicates that personal hotspot 10 is being powered by a household current. Regulator 52 may have access to a library of commands specific to data exchanger 20 that can be issued via device link 28 (FIG. 1). One or more of those commands may be for instructing data exchanger to alter its power source. Alternatively, regulator may simply instruct data exchanger interface 32 to power or not power data exchanger 20.

Regulator 52 may perform some of its responsibilities without user confirmation. Other actions may be taken based on a user selected option. For example, regulator 52 may determine that a particular predetermined threshold has been met. Following this determination, regulator 52 may cause web server 38 to access user interface data 46 and return content to a client device 12, 14, or 16. The returned content may include controls for selecting an action to be taken by regulator 52. Instead it may include informational content advising a user of an imminent action to be taken by regulator 52. For example, the returned content may warn the user that personal hotspot 10 or data exchanger 20 will be powered off unless the user takes steps to power one or both devices using household current.

FIG. 5 is a block diagram illustrating the logical elements of configuration data 44. In the example of FIG. 5, configuration data 44 includes power state data 54, activity data 56, action data 58, and threshold data 60. Power state data 54 represents power state information monitored and recorded by power monitor 48. Activity data 56 represents activity level information monitored and recorded by activity monitor 50.

Action data 58 represents various power regulation actions to be taken by regulator 52 to regulate the operational states of personal hotspot 10 and data exchanger 20. Action data 58, for example, may include a series of records where each record identifying one or more power regulation actions to be taken by regulator 52. Such actions include altering operational states to reduce or increase the power made available to personal hotspot 10 and data exchanger 20. Other actions include causing user interfaces to be returned to a user.

Threshold data 60 represents predetermined threshold values corresponding to power state data 54 and activity data 56. For example, threshold data 60 may include a series of records where each record includes an entry identifying a threshold power state, an entry identifying a threshold activity level such as an inactivity duration, and an entry identifying a particular power regulation action record in action data 58. In this scenario, regulator 52 can identify a record in threshold data 60 whose predetermined threshold values are being met by the values recorded in power state data 54 and activity data 56. For example, a given record may contain an entry specifying a power level and another entry identifying a period of inactivity. Upon identifying such a record in threshold data 60, regulator 52 identifies an associated action record in action data 68. That action record identifies a particular power regulation action. Such an action might involve increasing power, altering a power source, powering off, placing in a sleep mode, or causing a particular user interface to be communicated to a client device 12, 14, or 16. Regulator 52 can then implement the appropriate power regulation action.

FIG. 6 is a block diagram illustrating the logical elements of user interface data 44. In the example of FIG. 6, user interface data includes informational content 62, action content 64, and configuration content 66. Informational content 68 represents web pages or other content that can identify a current power state and activity level and any recommended actions to be taken by a user such as plugging personal hotspot 10 or data exchanger 20 into a wall socket.

Action content 64 represents web pages or other content having user accessible controls for specifying particular power regulation actions to be taken to alter the operational mode of personal hotspot 10 and data exchanger 20. Configuration content 72 represents web pages or other content used to update configuration data 44.

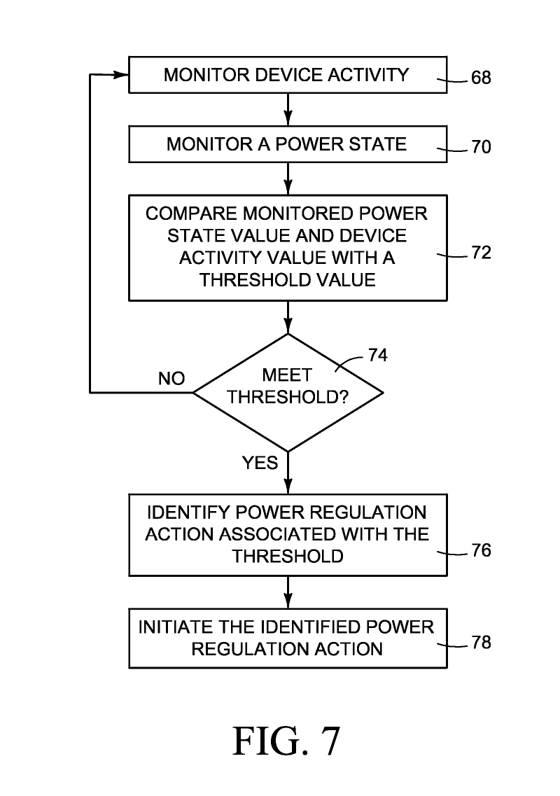

OPERATION: The operation of embodiments of the present invention will now be described with reference to FIG. 7. FIG. 7 is an exemplary flow diagram that helps illustrate actions taken to regulate the power state of personal hotspot 10 and data exchanger 20. The actions include monitoring device activity levels and power states (steps 68 and 70). Step 68, for example, may be performed by activity monitor 50 while step 70 may be performed by power state monitor 48. Step 68 can involve recording the monitored activity levels such as inactivity durations for personal hotspot 10 and data exchanger 20 in configuration data 44. Step 70 can involve recording the monitored power states for personal hotspot 10 and data exchanger 20 in configuration data 44.

The monitored power states and device activity levels are compared with predetermined threshold levels (step 72). As discussed the predetermined threshold levels can relate to a particular power state such as a battery level or power source. Predetermined threshold levels can also relate to durations of device inactivity for personal hotspot 10 and data exchanger 20. Step 72, for example, may be performed by regulator 52 which accesses configuration data 44 and compares recorded power states and activity levels with the threshold values in threshold data 60.

It is determined if a monitored device activity level and/or a monitored power state meet or meets a threshold value or values (step 74). Step 74 may be accomplished, by regulator 52 identifying a record in threshold data 60 that specifies threshold values being met by the activity levels and power states recorded in activity data 56 and power state data 54. If regulator 52 cannot identify such a record meaning that no thresholds are being met, the process repeats with step 68. If a threshold is being met, a power regulation action is identified (step 76). Continuing with the example, step 76 can involve regulator 52 identifying a power regulation action record in action data 58 that is associated with a threshold record whose threshold values are being met. From that identified action record, regulator 52 identifies the power regulation action.

The identified power regulation action is then initiated (step 78). Step 78 can involve regulator 52 implementing a particular action with or without user interaction. Such actions can include altering the operational states of personal hotspot 10 and data exchanger 20. Alterations, as already discussed, can include increasing or reducing available power as wells as changing power sources for a given device. Alterations can include placing a device in a full operational mode, a limited operational mode, a sleep mode, powering off the device, or cause one device to start or stop powering the other. Other power regulation actions can include causing user interfaces to be communicated to a client device 12, 14, or 16. Such user interfaces can be informational or can allow a user to select a particular action to be taken by regulator 52 to alter a power state of personal hotspot 10 or data exchanger 20.

CONCLUSION: The schematic diagrams of FIGS. 1 and 2 illustrate exemplary environments in which embodiments of the present invention may be implemented. Implementation, however, is not limited to these environments. The diagrams of FIGS. 3-6 show the architecture, functionality, and operation of various embodiments of the present invention. A number of the blocks are defined as programs. Each of those blocks may represent in whole or in part a module, segment, or portion of code that comprises one or more executable instructions to implement the specified logical function(s). Each block may represent a circuit or a number of interconnected circuits to implement the specified logical function(s).

Also, the present invention can be embodied in any computer-readable media for use by or in connection with an instruction execution system such as a computer/processor based system or an ASIC (Application Specific Integrated Circuit) or other system that can fetch or obtain the logic from computer-readable media and execute the instructions contained therein. “Computer-readable media” can be any media that can contain, store, or maintain programs and data for use by or in connection with the instruction execution system. Computer readable media can comprise any one of many physical media such as, for example, electronic, magnetic, optical, electromagnetic, or semiconductor media. More specific examples of suitable computer-readable media include, but are not limited to, a portable magnetic computer diskette such as floppy diskettes or hard drives, a random access memory (RAM), a read-only memory (ROM), an erasable programmable read-only memory, or a portable compact disc.

Although the flow diagram of FIG. 7 shows a specific order of execution, the orders of execution may differ from that which is depicted. For example, the order of execution of two or more blocks may be scrambled relative to the order shown. Also, two or more blocks shown in succession may be executed concurrently or with partial concurrence. All such variations are within the scope of the present invention.

The present invention has been shown and described with reference to the foregoing exemplary embodiments. It is to be understood, however, that other forms, details and embodiments may be made without departing from the spirit and scope of the invention that is defined in the following claims.

What is claimed is:

1. A power regulation method implemented by a personal hotspot, the personal hotspot being configured to utilize a data exchanger to provide internet access to one or more client devices, the method comprising:
monitoring a power state of one or both of the data exchanger and the personal hotspot
determining if the monitored power state meets a predetermined threshold value;
if the determination indicates that the predetermined threshold value is met, initiating a power regulation action associated with the threshold value.

2. The method of claim 1, further comprising monitoring an activity level of one or both of the data exchanger and the personal hotspot, and wherein determining comprises determining if one or both of the monitored power state and the monitored activity level meet predetermined threshold values.

3. The method of claim 2, wherein determining comprises determining if the monitored power state meets one or more of a first set of the predetermined threshold values and determining if the monitored activity level meet meets one or more of a second set of the predetermined threshold values.

4. The method of claim 1, wherein:
the personal hotspot is configured to supply power to the data exchanger;
monitoring the power state comprises identifying that the personal hotspot is operating on battery power at a particular battery level;
the predetermined threshold value is a predetermined battery level; and
the power regulation action is adjusting an operation state of the personal hotspot to reduce the power supplied to the data exchanger.

5. The method of claim 1, wherein:
the personal hotspot is configured to supply power to the data exchanger;
monitoring the power state comprises identifying that the personal hotspot is operating on household current;
the predetermined threshold value is an indicator that the personal hotspot is operating on household current; and
the power regulation action is adjusting an operation state of the personal hotspot to increase the power supplied to the data exchanger.

6. The method of claim 1, wherein initiating a power regulation action comprises causing a user interface to be communicated to one of the client devices, the user interface providing one or more of informational content and power regulation action content.

7. The method of claim 6, wherein the power regulation action content includes user accessible controls for selecting from among a plurality of power regulation actions and initiating a power regulation action comprises initiating a particular one of the plurality power regulation actions having been selected through the user interface.

8. The method of claim 1, wherein initiating a power regulation action comprises altering an operational state of one or both of the personal hotspot and the data exchanger to such that the power consumed by one or both of the personal hotspot and the data exchanger is reduced.

9. The method of claim 1, wherein initiating a power regulation action comprises altering an operational state of one or both of the personal hotspot and the data exchanger to such that the power consumed by one or both of the personal hotspot and the data exchanger is increased.

10. A computer readable medium having instructions configured for execution by a personal hotspot, the personal hotspot being configured to utilize a data exchanger to provide internet access to one or more client devices, the medium having instructions for:
monitoring a power state of one or both of the data exchanger and the personal hotspot
determining if the monitored power state meets a predetermined threshold value;
if the determination indicates that the predetermined threshold value is met, initiating a power regulation action associated with the threshold value.

11. The medium of claim 10, having further instructions for monitoring an activity level of one or both of the data exchanger and the personal hotspot, and wherein the instructions for determining include instructions for determining if one or both of the monitored power state and the monitored activity level meet predetermined threshold values.

12. The medium of claim 11, wherein the instructions for determining include instructions for determining if the monitored power state meets one or more of a first set of the predetermined threshold values and determining if the monitored activity level meet meets one or more of a second set of the predetermined threshold values.

13. The medium of claim 10, wherein:
the personal hotspot is configured to supply power to the data exchanger;
the instructions for monitoring the power state include instructions for identifying that the personal hotspot is operating on battery power at a particular battery level;
the predetermined threshold value is a predetermined battery level; and
the power regulation action is adjusting an operation state of the personal hotspot to reduce the power supplied to the data exchanger.

14. The medium of claim 10, wherein:
the personal hotspot is configured to supply power to the data exchanger;
the instructions for monitoring the power state include instructions for identifying that the personal hotspot is operating on household current;
the predetermined threshold value is an indicator that the personal hotspot is operating on household current; and
the power regulation action is adjusting an operation state of the personal hotspot to increase the power supplied to the data exchanger.

15. The medium of claim 10, wherein the instructions for initiating a power regulation action include instructions for causing a user interface to be communicated to one of the client devices, the user interface providing one or more of informational content and power regulation action content.

16. The medium of claim 15, wherein the power regulation action content includes user accessible controls for selecting from among a plurality of power regulation actions and the instructions for initiating a power regulation action include instructions for initiating a particular one of the plurality power regulation actions having been selected through the user interface.

17. The medium of claim 10, wherein the instructions for initiating a power regulation action include instructions for altering an operational state of one or both of the personal hotspot and the data exchanger to such that the power consumed by one or both of the personal hotspot and the data exchanger is reduced.

18. The medium of claim 10, wherein the instructions for initiating a power regulation action include instructions for altering an operational state of one or both of the personal hotspot and the data exchanger to such that the power consumed by one or both of the personal hotspot and the data exchanger is increased.

19. A personal hotspot configured to utilize a data exchanger to provide internet access to one or more client devices, the personal hotspot comprising:
a power monitor operable to monitor a power state of one or both of the data exchanger and the personal hotspot; and
a regulator operable to determine if the monitored power state meets a predetermined threshold value and to initiate a power regulation action associated with the threshold value if the determination indicates that the predetermined threshold value is met.

20. The personal hotspot of claim 19, further comprising an activity monitor operable to monitor an activity level of one or both of the data exchanger and the personal hotspot, and wherein the regulator is operable to determine if one or both of the monitored power state and the monitored activity level meet predetermined threshold values.

21. The personal hotspot of claim 20, wherein the regulator is operable to determine by determining if the monitored power state meets one or more of a first set of the predetermined threshold values and determining if the monitored activity level meet meets one or more of a second set of the predetermined threshold values.

22. The personal hotspot of claim 19, wherein:
the personal hotspot is configured to supply power to the data exchanger;
the power monitor is operable to identify that the personal hotspot is operating on battery power at a particular battery level;
the predetermined threshold value is a predetermined battery level; and
the power regulation action is adjusting an operation state of the personal hotspot to reduce the power supplied to the data exchanger.

23. The personal hotspot of claim 19, wherein:
the personal hotspot is configured to supply power to the data exchanger;
the power monitor is operable to identify that the personal hotspot is operating on household current;
the predetermined threshold value is an indicator that the personal hotspot is operating on household current; and
the power regulation action is adjusting an operation state of the personal hotspot to increase the power supplied to the data exchanger.

24. The personal hotspot of claim 19, wherein the regulator is operable to initiate a power regulation by causing a user interface to be communicated to one of the client devices, the user interface providing one or more of informational content and power regulation action content.

25. The personal hotspot of claim 24, wherein the power regulation action content includes user accessible controls for selecting from among a plurality of power regulation actions and wherein the regulator is operable to initiate a particular one of the plurality power regulation actions having been selected through the user interface.

26. The personal hotspot of claim 19, wherein the regulator is operable to initiate a power regulation action by altering an operational state of one or both of the personal hotspot and the data exchanger to such that the power consumed by one or both of the personal hotspot and the data exchanger is reduced.

27. The personal hotspot of claim 19, wherein the regulator is operable to initiate a power regulation action by altering an operational state of one or both of the personal hotspot and the data exchanger to such that the power consumed by one or both of the personal hotspot and the data exchanger is increased.
